(19) United States
(12) Patent Application Publication
(10) Pub. No.: US 2026/0368729 A1
(43) Pub. Date: Nov. 19, 2026

(54) Deterministic Settlement Messaging Protocol and Multi-Layer Evidence Architecture for Automated Wire Transfer Correspondence Verification and Lifecycle Management of Private Credit Securities Using Distributed Ledger Attestation

(71) Applicant: Joseph William O'Neill, JR., Boca Raton, FL (US)

(72) Inventor: Joseph William O'Neill, JR., Boca Raton, FL (US)

(21) Appl. No.: 19/541,231

(22) Filed: Feb. 16, 2026

(51) Int. Cl. G06Q 20/40; G06Q 20/42; G06Q 40/06; H04L 9/00; H04L 9/06

(52) U.S. Cl. CPC G06Q 20/401; G06Q 20/42; G06Q 40/06; H04L 9/0643; H04L 9/50; G06Q 2220/00; H04L 2209/125

(57) ABSTRACT

A computer-implemented network messaging protocol generates a deterministic bounded-length verification token from a canonical byte string of serialized attributes via SHA-256 hashing and suffix extraction, prefixed for compatibility with constrained messaging fields. The token enables distributed multi-node verification with attestations recorded on a privacy-preserving distributed ledger, computing a data corroboration value based on token concurrence for automated routing and state transitions in hybrid settlement architectures. A tamper-evident lineage threads immutable identifiers through layered records including lifecycle events, multi-party attestations, dual-mode settlements, and counterparty correspondence verifications. Position computation is automatically triggered by ledger-detected modification events, with convergence-bounded numerical solvers generating network control signals that govern transactional capability states. The protocol reduces ambiguity and latency in message processing for assets lacking standardized identifiers by providing cryptographic binding and consensus-driven automation in distributed environments.

### CROSS-REFERENCE TO RELATED APPLICATIONS

This utility patent application claims priority pursuant to 35 U.S.C. § 119 (e) to Provisional patent application Ser. No. ______, filed on Feb. 13, 2026, titled “Cryptographic Verification Code System and Multi-Layer Evidence Architecture for Deterministic Wire Transfer Correspondence Verification and Lifecycle Management of Private Credit Securities Using Distributed Ledger Attestation.” The entirety of that provisional application is incorporated by reference.

This application is submitted with a request for Prioritized Examination under 37 C.F.R. § 1.102 (e).

### FIELD OF THE INVENTION

The present invention relates generally to financial technology systems for settlement messaging and private credit securities administration, and more particularly to: (1) a method and system for generating cryptographic verification tokens derived from economic attributes of financial instruments, embedding said tokens in constrained-width message transport fields, and performing deterministic multi-party matching using distributed ledger attestation; and (2) a multi-layer evidence architecture that maintains a single immutable identifier thread through seven distinct layers of a private credit facility's lifecycle-from origination through daily accounting positions-to create an unbroken, auditable chain of custody compliant with PCAOB Auditing Standard No. 1105 and FASB ASC 310-20 effective interest rate accounting.

### BACKGROUND OF THE INVENTION

### 1. The Problem of Level 3 Securities Identification

Under Accounting Standards Codification (ASC) 820 “Fair Value Measurement” promulgated by the Financial Accounting Standards Board (FASB), financial instruments are classified into three levels based on the observability of inputs used in their valuation. Level 1 instruments (e.g., publicly traded equities) have readily available market identifiers such as CUSIP, ISIN, and SEDOL numbers. Level 2 instruments have observable market inputs. Level 3 instruments—including private credit loans, direct lending facilities, and bespoke debt instruments—have no observable market identifiers whatsoever.

This absence of standardized identifiers creates a fundamental operational challenge: when a wire transfer arrives at a fund administrator or custodian bank, there is no reliable mechanism to match that wire to the specific private credit security it references. Existing systems rely on human interpretation of non-deterministic character sequences in description fields and manual exception queue processing.

### 2. The Settlement Messaging Field Constraint Problem

Conventional wire transfer protocols (FedWire, CHIPS, SWIFT) impose strict character limits on remittance information fields. FedWire allows 16,000 characters, but practical message routing typically enforces 70-140 character limits on the memo/reference field to ensure interbank compatibility. Concurrently, complex private credit securities possess multi-attribute economic identity far exceeding these legacy protocol capacities.

Fund administrators, agents, and custodian banks currently spend significant manual effort reconciling wire transfers to security positions-a process that introduces settlement delays of 24 to 48 hours, increases operational risk, and requires dedicated reconciliation staff. Every mismatch or ambiguity triggers a manual exception queue entry.

### 3. The Lifecycle Fragmentation Problem

Beyond wire matching, private credit facilities suffer from lifecycle fragmentation. A typical facility passes through multiple operational phases: origination, component issuance (tranches, revolvers, delayed-draw term loans), lifecycle events (drawdowns, interest payments, principal payments, covenant tests, amendments), multi-party attestation, wire settlement, off-chain reconciliation with custodian bank records, and daily accounting position computation (carrying value, interest and fee accruals, reserve balances, and valuation adjustments). Each phase typically uses different identifiers, different systems, and different data formats, creating correspondence verification breaks at every boundary.

No existing system maintains a single immutable identifier that threads through all seven layers of this lifecycle while simultaneously computing FASB ASC 310-20 effective interest rate amortization and recording PCAOB AS 1105-compliant audit evidence at each transition.

### 4. Technical Improvements Over Prior Art

Conventional settlement messaging networks lack sufficient field capacity to transmit globally unique identifiers for private credit instruments. As a result, computing systems cannot deterministically route payment messages and instead rely on human interpretation of unstructured text fields, causing repeated database queries, exception queue growth, and network processing inefficiencies.

The disclosed system converts heterogeneous financial instrument attributes into a deterministic compact verification token specifically sized to fit legacy payment network transport fields. The token operates as a machine-interpretable routing primitive rather than a business identifier, enabling independent computing systems to reconstruct identical routing decisions without database synchronization.

The invention improves computer functionality by: (1) transforming non-deterministic message fields into deterministic routing signals; (2) eliminating repeated reconciliation database queries; (3) reducing settlement processing retries and network load; (4) enabling state machine automation in identifier-deficient networks; and (5) cryptographically binding off-network and on-ledger transaction states. This constitutes an improvement to electronic message processing, not financial practice.

Additionally, conventional wire transfer protocols (e.g., FedWire, SWIFT) impose strict character limits and formatting constraints on remittance information fields. The present invention provides a technical solution to this data transmission bottleneck. It employs a deterministic cryptographic compression technique to encapsulate complex, multi-attribute asset data into a fixed-length, protocol-compliant alphanumeric string. This improves the functioning of the computer network itself by: (1) enabling legacy banking hardware to process identifying information for complex assets without protocol modification, (2) reducing network bandwidth consumption by replacing variable-length descriptors with high-entropy short codes, and (3) eliminating the need for separate, asynchronous reconciliation data channels.

While the disclosed embodiments describe application in private credit securities messaging, the protocol architecture is domain-agnostic. The deterministic token generation, multi-node verification, and linked-list cryptographic data structures are applicable to any identifier-deficient transaction network including supply chain provenance verification, Internet of Things device identity management, and cross-organizational data synchronization systems where constrained message transport fields preclude transmission of full unique identifiers.

### 5. Limitations of Existing Solutions

The ISO 20022 messaging standard provides structured remittance information fields but standardizes the message format at the transport layer-it does not generate content-level verification codes derived from the security's economic attributes. The SWIFT UETR provides a 36-character random UUID for payment tracking but bears no semantic relationship to the underlying security. Existing wire reconciliation platforms (BlackLine, Kyriba, GTreasury, HighRadius) employ fuzzy matching rather than deterministic verification. Prior art patents addressing blockchain securities settlement (US20190392265, US20170069086, U.S. Pat. No. 10,366,392) disclose UUID assignment but do not integrate seven-layer lifecycle threading with cryptographic verification tokens, automated routing signals, convergence-bounded numerical solving, and multi-party attestation data corroboration scoring.

### SUMMARY OF THE INVENTION

### A. Network Messaging Verification Token

In a first aspect, the invention provides a computer-implemented network messaging verification method comprising: receiving a structured asset attribute record stored in memory; normalizing a plurality of heterogeneous asset attributes into fixed-width machine-parseable fields according to a predefined schema; generating a deterministic short-form transport verification token via cryptographic compression; injecting the verification token into a transaction reference field of an electronic payment message; transmitting the electronic payment message across a settlement messaging network; and automatically routing the electronic payment message to a settlement state based on verification token matching, without human intervention.

### B. Distributed Verification System

In a second aspect, the invention provides a distributed verification system for transaction settlement in identifier-deficient networks, comprising multiple independent verification nodes each storing non-identical partial transaction records, a deterministic token generator configured to produce identical bounded-length verification tokens from independently stored structured asset attributes, and a distributed ledger technology network node maintaining facility-level unique identifiers with a consensus routing engine that automatically transitions transactions between settlement states based solely on agreement of tokens generated by multiple independent nodes.

### C. Tamper-Evident Transaction Lineage

In a third aspect, the invention provides a tamper-evident transaction lineage tracking system comprising a distributed ledger storing a root transaction identifier assigned at facility origination, a plurality of linked child event identifiers deterministically derived from the root identifier, a multi-party attestation module recording cryptographically signed confirmations from five party roles, a deterministic verification token embedded in off-ledger settlement messages, a dual-mode settlement state machine configured to process transactions via either a five-state wire confirmation protocol or a three-state distributed ledger executable atomic execution, and an off-chain reconciliation module comparing on-ledger records with external counterparty records, whereby off-network payment messages are computationally anchored to a persistent seven-layer event history.

D. Non-Transitory Computer-Readable Medium with Verification Token Data Structure

In a fourth aspect, the invention provides a non-transitory computer-readable medium storing a data structure for deterministic identification of private credit securities in inter-institutional settlement messaging, comprising a registered prefix field, a verification token field of fixed hexadecimal characters extracted from a cryptographic hash digest, with a total serialized length of exactly eight characters compatible with legacy payment network message field constraints, wherein the verification token is deterministically reproducible from asset attributes without database lookup and cryptographically bound to the economic identity of the financial instrument.

### DETAILED DESCRIPTION OF THE INVENTION

### 1. System Architecture Overview

The system comprises four cooperating subsystems: (A) a Verification Token Generator that produces deterministic tokens from security economic attributes optimized for constrained message transport fields; (B) a Distributed Ledger Attestation Layer operating on the Canton Network using the Daml smart contract language; (C) a Routing Engine with data corroboration value-based state transition logic; and (D) an Evidence Spine Controller that maintains the facility identifier continuity across seven lifecycle layers with synchronous FASB 91 accounting and daily position computation.

### 2. Network Messaging Verification Token Generation

The system constructs a deterministic verification token from structured asset attributes, encoded for embedding in constrained-width message transport fields:
{BORROWER}-{TRANCHE} {NUM}-{YYMMDD}-{RATE}-{SPREAD}-{FUND}:{VERIFY}
   Example: ABCD-TL1-250115-FLT-1500-WXYZ:E7F2

| Component | Length | | Encoding Rule |
|---|---|---|---|
| BORROWER | 4 | chars | First 4 alphanumeric characters of borrower legal name, uppercase, |
| | | | non-alphanumeric stripped. Default: “UNKN”. |
| TRANCHE | 2-3 | chars | 2-char code from mapping: TERM_LOAN→TL, REVOLVER→RV, |
| | | | DELAYED_DRAW→DD, BRIDGE→BR, SUPER_SENIOR→SS, |
| | | | SECOND_LIEN→SL, MEZZ→MZ, UNITRANCHE→UT, ABL→AB. |
| | | | Suffixed with component number (1-9). |
| YYMMDD | 6 | digits | Origination date: two-digit year, two-digit month, two-digit day. |
| | | | Zero-padded. |
| RATE | 3 | chars | Rate type: FLOATING→FLT, FIXED→FIX, PIK→PIK, |
| | | | PIK_TOGGLE→PKT. |
| SPREAD | 4 | digits | Credit spread in basis points, zero-padded to 4 digits (0000-9999). |
| FUND | 4 | chars | First 4 alphanumeric characters of fund name, uppercase. |
| | | | Default: “FUND”. |
| VERIFY | 4 | hex | Last 4 characters of SHA-256 hex digest of pipe-delimited |
| | | | concatenation of all preceding components, uppercase. |

### 3. Verification Token Generation Algorithm

Step 1—Attribute Normalization: Each economic attribute is normalized to a fixed-length string according to the encoding rules above. All string components converted to uppercase; numeric components zero-padded.
Step 2—Canonical String Formation: Normalized components concatenated using pipe delimiter (“|”) in fixed order: BORROWER|TRANCHE|YYMMDD|RATE|SPREAD|FUND. Example: “ABCD|TL1|250115|FLT|1500|WXYZ”.
Step 3—Cryptographic Hashing: SHA-256 (FIPS PUB 180-4) applied to canonical byte string, producing 64-character hexadecimal digest.
Step 4—Token Extraction: Last four hex characters extracted, uppercased, and converted to uppercase, yielding a bounded-length collision-controlled suffix with 65,536 possible values (16\hat{ }4)-collision-resistant for institutional portfolios (typically <10,000 active positions).
Step 5—Transport Field Formatting: Token prefixed with “ENV-” producing an 8-character fixed-length verification token compatible with legacy message field constraints.

### 4. Key Properties of the Deterministic Token

Determinism: Identical inputs always produce identical tokens. No randomness, timestamps, or database sequences. Enables reproducibility.

Cryptographic Integrity: SHA-256 avalanche effect ensures single-character input change produces completely different token.

Statelessness: Pure function—no database lookups, network calls, or shared state. Enables offline verification and independent reconstruction.

Transport Compactness: 8-character fixed-length format fits within the most restrictive message transport field constraints (FedWire, CHIPS, SWIFT).

Collision Resistance: SHA-256 basis provides cryptographically strong collision resistance. Four-character suffix supports 65,536 values, suitable for portfolios <10,000 positions.

### 5. Multi-Party Distributed Verification

Party 1—Fund Manager (Token Generator): Generates asset attributes and verification token from facility data, assigns token to security position on distributed ledger, communicates token to counterparties via network message.

Party 2—Administrative Agent (Independent Verifier): Independently verifies token against loan documentation stored locally, computes expected token from own records, records signed attestation on ledger.

Party 3—Custodian Bank (Network Matcher): Receives network message containing token, regenerates expected token from own transaction records, independently confirms match, records confirming or disconfirming attestation.

| Score | Classification | System Action |
|---|---|---|
| 3 | FULL_MATCH | All 3 parties confirmed. Automatic settlement without |
| | | exception queue. No intervention required. |
| 2 | PARTIAL_MATCH | 2 of 3 confirmed. Auto-settle with notification to |
| | | non-confirming party. ~2 hours. |
| 1 | WEAK_MATCH | 1 of 3 confirmed. Route to manual reconciliation |
| | | queue. ~8 hours. |
| 0 | NO_MATCH/BREAK | No confirmation. Immediate exception escalation. ~24 hours. |

### 6. Dual-Mode Settlement Execution

Wire Transfer Mode: Five-state settlement machine (INITIATED→WIRE SENT→AGENT_CONFIRMED→BANK_MATCHED→SETTLED). T+1/T+2 timeline. Verification token embedded in wire memo field. Consensus routing based on three-party token agreement.

Distributed Ledger Executable Atomic Mode: Three-state settlement machine (INITIATED→DLE EXECUTED→SETTLED). Atomic settlement (~1 second). Verification token embedded in DLE payload. Zero wire description matching friction.

### 7. Seven-Layer Evidence Architecture

The Evidence Spine maintains a single facility identifier that threads through every operational layer, creating an unbroken chain of custody:

| Layer | Name | Function |
|---|---|---|
| 1 | Facility | Facility identifier assigned at facility creation on distributed ledger. This |
| | Origination | identifier persists as the immutable thread through all subsequent layers. |
| | | Distributed ledger event ID and signatory hash recorded. Represents facility |
| | | origination event. |
| 2 | Component | Component identifiers assigned to each loan tranche (term loan, revolver, |
| | Issuance | delayed-draw), linked to parent facility identifier. Each component inherits |
| | | the facility's distributed ledger attestation chain. Represents component |
| | | origination. |
| 3 | Lifecycle | Comprehensive lifecycle events recorded with facility identifier, distributed |
| | Events | ledger event ID, and signatory hash. Immutable event log. Timestamped and |
| | | sequenced. Events include financial transactions (fundings, drawdowns, |
| | | paydowns, payoffs, prepayments, principal exchanges), income and accrual |
| | | computations (interest accruals, PIK capitalizations, fee accruals, deferred fee |
| | | amortization), reserve and valuation adjustments (expected credit loss |
| | | reserves, fair value marks, impairment determinations), structural |
| | | modifications (borrowing base recalculations, covenant certifications, |
| | | participant assignments), and regulatory compliance recordings. |
| 4 | Multi-Party | Five-party attestation per PCAOB AS 1105: Operator, Agent, Administrator, |
| | Attestation | Borrower, Fund Manager. Each attestation is a signed hash on distributed |
| | | ledger, linked to facility identifier. Confirmation rates tracked per role and |
| | | per facility. |
| 5 | Wire | Dual-mode (wire/stablecoin) settlement using verification token derived from |
| | Settlement | facility's economic attributes. Three-party matching (Fund, Agent, Bank) |
| | | with data corroboration value scoring (0-3). Deterministic routing. |
| 6 | Off-Chain | Automated comparison of on-chain records with off-chain custodian records |
| | Correspondence | maintained by administrative agents, custodian banks, fund administrators, |
| | Verification | and other counterparties. Discrepancy detection and escalation. |
| | | Cryptographic proof linking. |
| 7 | Daily Accounting | Synchronous computation of daily position records comprising principal |
| | Positions | balances, carrying values, income accruals, reserve balances, amortization |
| | | schedules, and valuation adjustments, enabling reconstruction of the complete |
| | | financial state of each instrument as of any historical valuation date. |

### 8. Daily Accounting Position Computations

The system maintains a position ledger data store of daily accounting positions keyed by the facility identifier and valuation date. Each position record comprises:

Daily position computations including but not limited to: effective interest rate amortization, original issue discount amortization, fee amortization, payment-in-kind interest capitalization, accrued interest at stated and default rates, expected credit loss reserve computations, carrying value adjustments, fair value estimates, and net asset value contributions.

These daily computations enable reconstruction of the complete financial state of each instrument as of any historical date and support comprehensive net asset value computation for valuation, reporting, and audit compliance purposes.

### 9. Convergence-Bounded Numerical Solver for Position Computation

The system implements convergence-bounded iterative numerical solving for position parameter derivation using Newton-Raphson numerical methods. The rate parameter is derived as the value (r) that equates the net investment to the present value of all expected future cash flows:

$$Net Investment = \sum [ CF\_t / ( 1 + r ) ⋀ ( t / 365 ) ]$$

Where Net Investment=Principal−OID+Origination Fees−Direct Costs; CF_t=expected cash flow at time t; r=annualized rate parameter (the unknown); t=days from origination. Newton-Raphson iteration: r(n+1)=r(n)−f(r(n))/f(r(n)), with convergence tolerance of 10\hat{ }-10 and rate clamped to 0%-50% range.

The rate parameter is automatically recalculated upon: rate resets (floating rate adjustments), maturity extensions, prepayments, and facility amendments. The solver generates network control signals based on convergence outcomes: when the computed rate parameter falls outside predefined bounds or fails to converge within maximum iterations, the system automatically restricts transactional capability of the associated instrument record on the distributed ledger. Daily position calculation per diem is derived from the rate differential over the remaining term.

In preferred embodiments, the convergence-bounded numerical solver executes on hardware equipped with cryptographic acceleration capabilities such as Hardware Security Modules (HSM) for key material management and Trusted Execution Environments (TEE) such as Intel SGX or ARM TrustZone for confidential computation of sensitive cash flow arrays. These hardware components ensure that the cryptographic operations are performed in tamper-resistant environments and the iterative solver output is protected from observation during computation.

In the statistically rare event of a hash collision where two distinct canonical byte strings produce identical four-character suffixes (probability approximately 1 in 65,536 per pair), the system detects the collision through the multi-node verification process and appends a disambiguation salt value to the canonical string before rehashing, ensuring uniqueness without exceeding transport field length constraints.

### 10. Facility Identifier Continuity and Chain of Custody

The system provides continuity of the facility identifier through every operational phase of the instrument's lifecycle. The same facility identifier appears consistently across: facility origination, component issuance, lifecycle event recording, multi-party attestation, wire settlement verification, off-chain correspondence verification, and daily position computation. No identifier translation or mapping tables are required. The facility identifier is the spine that binds all seven layers.

1. A distributed settlement system for automated transaction verification in networks in which no single participant node stores all attributes required to independently reconstruct a complete transaction record, the system comprising:
a. a plurality of geographically distributed verification nodes, each node storing a partial subset of transaction attributes and operating independently of other verification nodes;
b. a deterministic verification token generator configured to receive transaction attributes from at least one verification node, normalize said attributes into a canonical ordered format, concatenate the normalized attributes using a predetermined delimiter, compute a SHA-256 cryptographic hash of the concatenated string, extract a bounded-length suffix from the hash output, and prepend a domain-specific prefix to produce a deterministic verification token of predetermined character length;
c. a data corroboration engine configured to receive independently generated verification tokens from at least two of the plurality of verification nodes and compute a discrete corroboration score on a scale of 0 to 3 by comparing said tokens, wherein the corroboration engine routes transactions based on the corroboration score according to defined thresholds: a score of 3 triggers automated settlement processing, a score of 2 triggers a notification with a 2-hour review window, a score of 1 triggers manual review with an 8-hour escalation window, and a score of 0 triggers a 24-hour escalation protocol;
d. a dual-mode settlement controller comprising:
i. a wire settlement pathway implementing a 5-state transition sequence of INITIATED, WIRE_SENT, AGENT_CONFIRMED, BANK_MATCHED, and SETTLED states with settlement timing constraints, and
ii. a distributed ledger execution pathway implementing a 3-state transition sequence of INITIATED, DLE_EXECUTED, and SETTLED states with sub-second settlement capability, wherein the dual-mode settlement controller selects between the wire settlement pathway and the distributed ledger execution pathway based on the corroboration score and platform capability of the participating nodes; and
e. an immutable attestation record stored on a distributed ledger, the attestation record comprising the verification tokens, the corroboration score, the selected settlement pathway, and a timestamp for each state transition, whereby the system enables automated settlement of transactions without requiring any single node to possess a complete transaction record.

2. The system of claim 1, wherein at least one of the plurality of verification nodes generates the deterministic verification token while operating without a network connection to other verification nodes, and subsequently synchronizes the generated token upon restoration of network connectivity.

3. The system of claim 1, further comprising a role-weighted attestation module configured to require cryptographic signatures from M of N designated attestation roles before recording a settlement state transition on the distributed ledger, wherein each role is assigned a weight based on its verification authority.

4. The system of claim 1, wherein the wire settlement pathway further comprises a three-party matching step requiring confirmation from at least: a sending institution, a receiving institution, and an intermediary agent, before transitioning from the AGENT_CONFIRMED state to the BANK_MATCHED state.

5. The system of claim 1, wherein the immutable attestation record is implemented as a smart contract on a distributed ledger platform that enforces state transition ordering constraints, preventing any settlement state from being recorded out of sequence.

6. The system of claim 1, further comprising a three-stage reconciliation cascade wherein: a first stage performs automated token comparison, a second stage performs attribute-level variance analysis on mismatched tokens, and a third stage generates a structured exception report for manual resolution.

7. The system of claim 1, wherein the deterministic verification token generator is further configured to: detect hash collisions between distinct transaction attribute sets by comparing the bounded-length suffixes, and upon detection, append a deterministic salt value derived from a secondary attribute to the concatenated string and recompute the SHA-256 hash to produce a collision-resolved verification token.

8. The system of claim 1, wherein the deterministic verification token generator produces tokens for a private credit domain using a schema comprising: a borrower identifier, a tranche identifier, a date value in YYMMDD format, a rate value in basis points, a spread value in basis points, and a fund identifier, concatenated using pipe delimiters.

9. A computer-implemented method for computing net investment positions within a hardware-isolated secure execution environment, the method comprising:
a. receiving, at a computing node operating within a hardware security module or trusted execution environment providing hardware-enforced memory isolation, a set of cash flow records each comprising a payment amount, a payment date, and a day-count basis parameter D selected from the group consisting of: D-360 for the 30/360 convention, D=365 for the ACT/365 convention, and D-360 with actual elapsed days as numerator for the ACT/360 convention;
b. executing, within the hardware-isolated secure execution environment, an iterative rate-solving computation using a Newton-Raphson method applied to the function f(r)=summation of [CF_t/(1+r)\hat{ }(t/D)] over all cash flow records, with an initial rate search bounded between 0% and 50% and a convergence tolerance of less than or equal to 10\hat{ }-10;
c. maintaining, in memory isolated by the hardware security module or trusted execution environment, a running principal balance that is updated with each cash flow record processed by the iterative solver;
d. generating a hash-chain linking each computed daily position record to the underlying transaction payload records from which it was derived, wherein each position record includes a cryptographic hash of the prior position record concatenated with the current transaction data;
e. upon a determination that the iterative solver has failed to converge within a predetermined number of iterations, recording a non-convergence attestation event on a distributed ledger and restricting transactional capability of the associated credit facility by generating a network control signal that prevents settlement processing; and
f. upon successful convergence, recording the computed position value, the convergence metadata, and an attestation proof to the distributed ledger, whereby the method replaces manual position computation with a deterministic, hardware-attested computation that produces cryptographically verifiable position records.

10. The method of claim 9, wherein the day-count basis parameter D is retrieved from a record stored on a distributed ledger that specifies the contractual day-count convention for each facility.

11. The method of claim 9, wherein the hardware-isolated secure execution environment maintains a sealed state comprising the current principal balance, the last computed rate, and a checkpoint counter, and periodically writes an encrypted checkpoint of the sealed state to persistent storage outside the hardware-isolated secure execution environment for recovery purposes.

12. The method of claim 9, further comprising maintaining a state machine that records each computational step as an auditable state transition, wherein the state machine transitions include: INITIALIZED, CASH_FLOWS_LOADED, SOLVER_EXECUTING, CONVERGED, NON_CONVERGED, ATTESTED, and SETTLED.

13. The method of claim 9, wherein the running principal balance is maintained as an enhanced balance vector comprising: the outstanding principal, accrued interest, any original issue discount amortization, any paid-in-kind interest capitalization, and metadata identifying the facility and tranche from which each component derives.

14. The method of claim 9, wherein the hash-chain further implements a Merkle tree structure over a set of daily position records, enabling O (log n) verification of any individual position record against a Merkle root stored on the distributed ledger.

15. The method of claim 9, further comprising automatically triggering a recomputation of the net investment position upon detection of any of the following recalculation events: a rate reset, a maturity extension, a prepayment, a facility amendment, a covenant change, or a spread adjustment.

16. The method of claim 9, wherein the iterative rate-solving computation is accelerated by hardware cryptographic co-processors within the hardware security module, and wherein the attestation proof comprises a hardware-signed attestation report generated by the trusted execution environment confirming the integrity of the computation.

17. A system for maintaining facility identifier continuity across a multi-layer evidence architecture implemented on a distributed ledger, the system comprising:
a. a first layer comprising a facility origination module that generates a unique facility identifier and records the facility origination event on the distributed ledger, wherein the unique facility identifier serves as a canonical key for all subsequent layers;
b. a second layer comprising a component issuance module that records tranche issuance events using a deterministic encoding scheme with tranche type codes selected from the group consisting of: TL, RV, DD, BR, SS, SL, MZ, UT, and AB, followed by a numeric sequence identifier, wherein each tranche record is cryptographically linked to the facility identifier from the first layer;
c. a third layer comprising a lifecycle event recorder that records rate resets, draws, paydowns, amendments, and covenant changes, each event record comprising the facility identifier, a timestamp, and a cryptographic hash linking the event to the most recent prior event for the same facility;
d. a fourth layer comprising a multi-party attestation module requiring cryptographic signatures from at least 2 of 5 designated attestation roles before recording a lifecycle event as attested, the designated roles comprising: an operator, an administrative agent, an administrator, a borrower, and a fund manager;
e. a fifth layer comprising a settlement verification module that generates deterministic verification tokens from normalized transaction attributes associated with the facility identifier, computes a SHA-256 hash of the normalized attributes, and verifies settlement completion through comparison of independently generated tokens across a plurality of verification nodes;
f. a sixth layer comprising a correspondence reconciliation module that matches off-ledger communications to on-ledger transaction records using the facility identifier as a canonical matching key; and
g. a seventh layer comprising a position computation module that computes daily net investment positions using a convergence-bounded iterative solver operating within a hardware-isolated secure execution environment, wherein the position computation module retrieves cash flow records by traversing the hash-chain linkages from the seventh layer back through the second layer using the facility identifier as the canonical key without requiring intermediate identifier mapping between layers, whereby the same facility identifier threads through all seven layers as a canonical key, enabling end-to-end auditability from origination through daily position computation.

18. The system of claim 17, wherein the component issuance module supports issuance of up to 9 tranches per facility, each tranche assigned a unique tranche type code and numeric sequence identifier.

19. The system of claim 17, wherein the deterministic encoding scheme of the second layer further comprises a collision disambiguation protocol that appends a deterministic salt derived from a secondary facility attribute to the encoding input and, upon detection of a hash collision in the cryptographic linking of step (b), computes an updated cryptographic hash from the combined encoding input and salt to resolve the collision.

20. The system of claim 17, wherein the lifecycle event recorder of the third layer implements an append-only, tamper-evident chain in which each event record includes a cryptographic hash of the immediately preceding event record for the same facility, preventing retroactive modification of the lifecycle history.

21. The system of claim 17, wherein the multi-party attestation module of the fourth layer implements a role-weighted attestation scheme in which the designated attestation roles are each assigned a weight based on verification authority to satisfy the signature requirement.

22. The system of claim 17, wherein the position computation module of the seventh layer stores computed position values within a hardware security module or trusted execution environment, and periodically writes encrypted checkpoint records comprising the current position value, the computation timestamp, and a hardware attestation proof to the distributed ledger.

23. The system of claim 17, wherein the position computation module of the seventh layer computes net investment position values using the formula f(r)=summation of [CF_t/(1+r)\hat{ }(t/D)], where D is a day-count basis parameter selected from the group consisting of: D=360 for the 30/360 convention, D=365 for the ACT/365 convention, and D=360 with actual elapsed days as numerator for the ACT/360 convention, with Newton-Raphson convergence tolerance of less than or equal to 10\hat{ }-10.

24. The method of claim 13, wherein the enhanced balance vector further comprises original issue discount amortization and deferred fee amortization components computed in accordance with FASB ASC 310-20, each component linked through the hash-chain to its originating lifecycle event.

25. The method of claim 13, wherein the enhanced balance vector further comprises fee amortization, payment-in-kind capitalization, expected credit loss reserve, and fair value estimate components, enabling comprehensive net asset value computation for each instrument.

26. The method of claim 9, wherein the iterative rate-solving computation derives the effective interest rate for loan origination fee amortization and original issue discount recognition in accordance with FASB ASC 310-20, the convergence tolerance of 10\hat{ }-10 providing computational precision for financial statement preparation under generally accepted accounting principles.

27. The method of claim 12, wherein state transitions associated with solver iterations and convergence outcomes are recorded on the distributed ledger as immutable computation records usable as audit evidence under PCAOB Auditing Standard No. 1105.

28. The system of claim 17, wherein the facility identifier and the multi-layer evidence architecture are configured for financial instruments classified as Level 3 under FASB ASC 820 Fair Value Measurement, said instruments lacking observable market identifiers, and wherein the deterministic verification tokens of the fifth layer serve as machine-generated substitute identifiers enabling automated settlement verification and reconciliation for instruments that would otherwise require manual reconciliation.

29. The system of claim 17, wherein the multi-layer evidence architecture preserves the facility identifier across the seven layers and generates immutable audit evidence records usable under PCAOB Auditing Standard No. 1105, such continuity enabling end-to-end reconstruction of the complete financial state of each credit instrument as of any historical valuation date without requiring identifier translation between layers.

30. The system of claim 17, wherein the multi-party attestation of the fourth layer requires signed attestations from at least two of the five designated attestation roles, each attestation recorded as a signed hash on the distributed ledger linked to the facility identifier, thereby generating audit evidence records under PCAOB Auditing Standard No. 1105.
